(19) United States
(12) Patent Application Publication
(10) Pub. No.: US 2025/0260739 A1
(43) Pub. Date: Aug. 14, 2025

(54) SECURITY NETWORK SYSTEM MOUNTED INSIDE VEHICLE AND COMMUNICATION METHOD OF THE SAME

(71) Applicant: SAMSUNG ELECTRONICS CO., LTD, SUWON-SI (KR)

(72) Inventor: Yongtaek Jeong, Suwon-si (KR)

(21) Appl. No.: 18/782,527

(22) Filed: Jul. 24, 2024

(30) Foreign Application Priority Data
Feb. 13, 2024 (KR) 10-2024-0020138

(51) Int. Cl. H04L 67/12; H04L 9/40; H04L 12/40

(52) U.S. Cl. CPC H04L 67/12; H04L 12/40; H04L 63/08; H04L 2012/40273

(57) ABSTRACT

A security network system for a vehicle includes electronic control units (ECUs), a global bus, and group control units (GCUs) connected to the global bus, wherein each GCU of the GCUs is connected to at least one ECU of the ECUs, wherein a transmission ECU of the ECUs transmits a local data packet including a transmission ECU identifier and a transmission ECU authentication value to a GCU connected to the transmission ECU, wherein the GCU includes a first security checker configured to store ECU security information respectively corresponding to the ECUs, upon receipt of the local data packet, extract from the ECU security information a transmission ECU security information corresponding to the transmission ECU identifier included in the local data packet, and perform authentication of the local data packet based on the transmission ECU security information and the transmission ECU authentication value included in the local data packet.

### CROSS-REFERENCE TO RELATED APPLICATION

This application claims priority under 35 USC § 119 to Korean Patent Application No. 10-2024-0020138, filed on Feb. 13, 2024, in the Korean Intellectual Property Office (KIPO), the disclosure of which is incorporated by reference herein in its entirety.

### BACKGROUND

### 1. Technical Field

Example embodiments of the present disclosure relate generally to a security network system, and more particularly to a security network system for a vehicle and a communication method of the security network system.

### 2. Discussion of the Related Art

Electronic control units (ECUs) are microprocessor-based units commonly used in vehicles to manage electrical and electronic systems. For example, ECUs may be used to control and regulate functions in a vehicle including engine management, transmission control, braking, and climate control.

These ECUs may communicate with each other via a network, such as a Controller Area Network (CAN bus), a Local Interconnect Network (LIN), the FlexRay protocol, or an Ethernet. In a networked system, each ECU and the network itself may be vulnerable to attack, and more particularly cyber-attack.

### SUMMARY

Some example embodiments may provide a security network system and a communication method, capable of reinforcing security inside a vehicle.

According to example embodiments, a security network system for a vehicle includes a plurality of electronic control units (ECUs), a global bus, and a plurality of group control units (GCUs) connected to the global bus, wherein each GCU of the plurality of GCUs is connected to at least one ECU of the plurality of ECUs, wherein a transmission ECU of the plurality of ECUs is configured to transmit a local data packet including a transmission ECU identifier and a transmission ECU authentication value to a GCU connected to the transmission ECU, wherein the GCU includes a first security checker configured to store a plurality of ECU security information respectively corresponding to the plurality of ECUs, upon receipt of the local data packet, extract from the plurality of ECU security information a transmission ECU security information corresponding to the transmission ECU identifier included in the local data packet, and perform authentication of the local data packet based on the transmission ECU security information and the transmission ECU authentication value included in the local data packet.

According to example embodiments, a security network system mounted inside a vehicle includes a security checker and a plurality of electronic control units (ECUs). An ECU of the plurality of ECUs is connected to the security checker via a local bus and the ECU is configured to transmit a local data packet including a transmission ECU identifier, a transmission ECU authentication value and a reception ECU identifier to the security checker via the local bus. The security checker is configured to store a plurality of ECU security information corresponding to the plurality of ECUs, upon receipt of the local data packet, extract from the plurality of ECU security information a transmission ECU security information corresponding to the transmission ECU identifier included in the local data packet, and perform authentication of the local data packet based on the transmission ECU security information and the transmission ECU authentication value included in the local data packet.

According to example embodiments, a communication method of a security network system inside a vehicle, includes, storing, in a security checker, a plurality of electronic control unit (ECU) security information corresponding to a plurality of ECUs, receiving, by the security checker, a local data packet including a transmission ECU identifier, a transmission ECU authentication value and a reception ECU identifier, extracting, by the security checker, from the plurality of ECU security information a transmission ECU security information corresponding to the transmission ECU identifier, and performing, by the security checker, authentication of the local data packet based on the transmission ECU security information and the transmission ECU authentication value.

A security network system and a communication method according to example embodiments may enhance communication security in a vehicle by reducing security vulnerabilities wherein each ECU does not need to know the security information of other ECUs. The enhanced communication security may prevent or inhibit malicious attacks and enhances the reliability of the vehicle.

Furthermore, a security network system and a communication method according to example embodiments may be advantageous in terms of scalability and may be adapted to a centralized architecture, as a security checker may be updated when the network is updated.

### BRIEF DESCRIPTION OF THE DRAWINGS

Example embodiments of the present disclosure will be more clearly understood from the following detailed description taken in conjunction with the accompanying drawings.

FIG. 1 is a diagram illustrating a security network system according to example embodiments.

FIG. 2 is a flowchart illustrating a communication method of security network system according to example embodiments.

FIG. 3 is a diagram illustrating an example embodiment of Electronic Control Unit (ECU) security information in a security network system according to example embodiments.

FIG. 4 is a diagram illustrating a format of data packets as prescribed by Controller Area Network (CAN) protocol.

FIG. 5 is a diagram illustrating a local data packet in a security network system according to example embodiments.

FIG. 6 is a diagram illustrating an example embodiment of authentication in a security network system according to example embodiments.

FIG. 7A, FIG. 7B and FIG. 7C are diagrams illustrating a security network system according to example embodiments.

FIG. 8 is a diagram illustrating an example embodiment of Group Control Unit (GCU) security information in a security network system according to example embodiments.

FIG. 9 is a diagram illustrating an intra-group communication and an inter-group communication in a security network system according to example embodiments.

FIG. 10 is a diagram illustrating an inter-group communication in a security network system according to example embodiments.

FIG. 11 is a diagram illustrating a global data packet in a security network system according to example embodiments.

FIG. 12 is a flowchart illustrating a communication method of a security network system according to example embodiments.

FIG. 13 is a diagram illustrating an inter-group communication in a security network system according to example embodiments.

FIG. 14 is a diagram illustrating an example embodiment of a GCU included in a security network system according to example embodiments.

FIG. 15 is a block diagram illustrating an autonomous driving device including a security network system according to example embodiments.

### DETAILED DESCRIPTION

Various example embodiments will be described more fully hereinafter with reference to the accompanying drawings, in which some example embodiments are shown. In the drawings, like numerals refer to like elements throughout. Repetitive descriptions of one or more elements may be omitted.

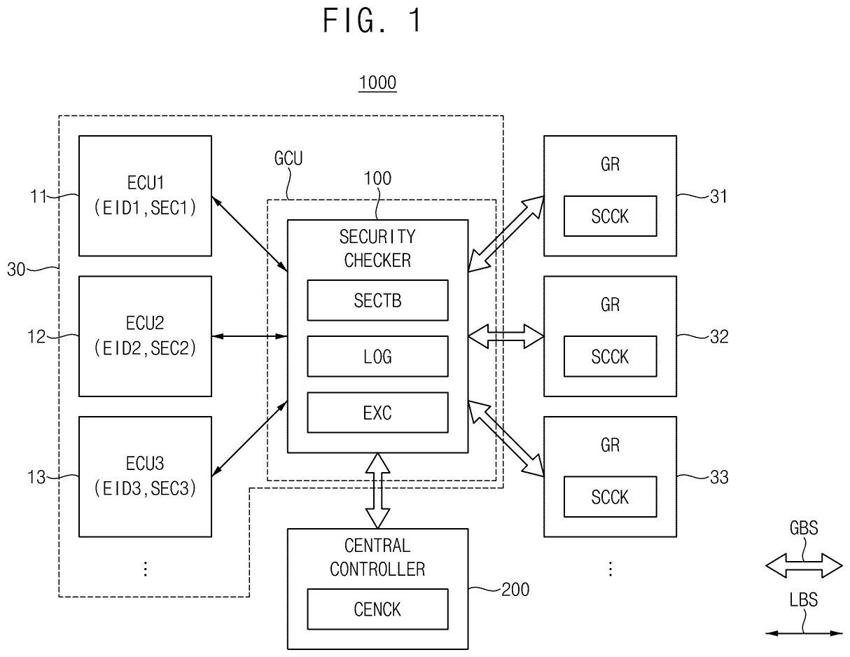

FIG. 1 is a diagram illustrating a security network system according to example embodiments.

Referring to FIG. 1, a security network system 1000 may include a plurality of control groups (GRs), including a first control group 30, a second control group 31, a third control group 32, and a fourth control group 33, and a central controller 200. The plurality of control groups 30, 31, 32 and 33 and central controller 200 may be interconnected via a global bus GBS. While FIG. 1 illustrates a configuration corresponding to the first control group 30 for convenience of illustration and description, the second control group 31, the third control group 32, and the fourth control group 33 may have the same or similar configurations as the configuration of the first control group 30 illustrated in FIG. 1.

The first control group 30 may include a plurality of Electronic Control Units (ECUs) (first ECU1 11, second ECU2 12, and third ECU3 13) and a security checker 100. As shown in FIG. 1, the second control group 31, the third control group 32, and the fourth control group 33 may each include a security checker SCCK. Also, although not shown in FIG. 1, the second control group 31, the third control group 32, and the fourth control group 33 may each include one or more ECUs.

The plurality of ECUs (first ECU1 11, second ECU2 12, and third ECU3 13) in the control group 30 may be connected to the security checker 100 via a local bus LBS. For convenience of illustration and explanation, an example of three ECUs (first ECU1 11, second ECU2 12, and third ECU3 13) connected to the security checker 100 is shown in FIG. 1, but the number of ECUs connected to each security checker may be varied.

The plurality of ECUs (first ECU1 11, second ECU2 12, and third ECU3 13) may store respective ECU identifiers and respective ECU security information. For example, the first ECU 11 may store a first ECU identifier EID1 and a first ECU security information SEC1, the second ECU 12 may store a second ECU identifier EID2 and a second ECU security information SEC2, and the third ECU 13 may store a third ECU identifier EID3 and a third ECU security information SEC3. The plurality of ECUs (first ECU1 11, second ECU2 12, and third ECU3 13) may generate a transmission ECU authentication value based on the respective ECU security information, and transmit a local data packet including the transmission ECU authentication value to the security checker 100. According to example embodiments, the security checker 100 may store a plurality of ECU security information that may be a collection of the respective ECU security information stored in each ECU of the first through third of ECUs ECU1, ECU2, and ECU3.

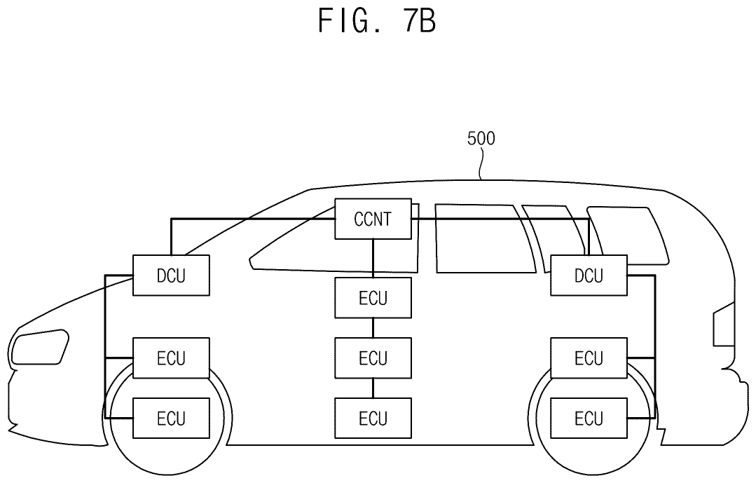

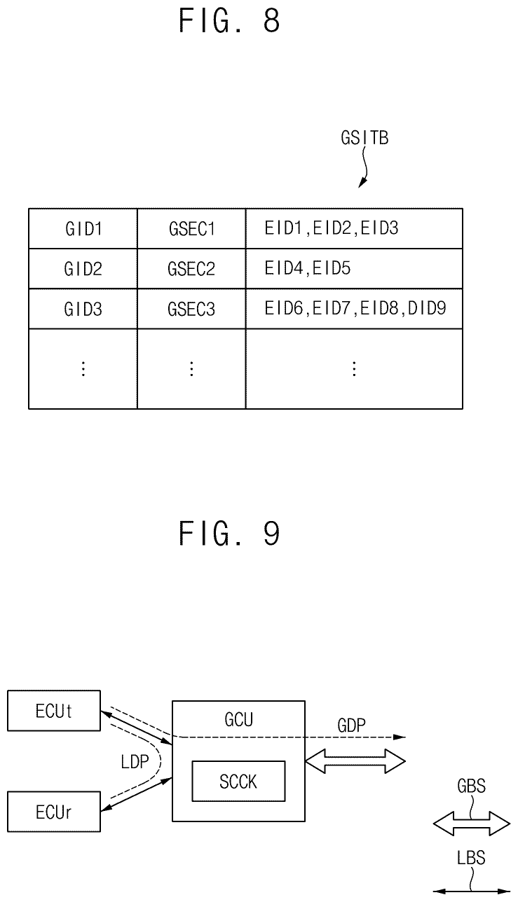

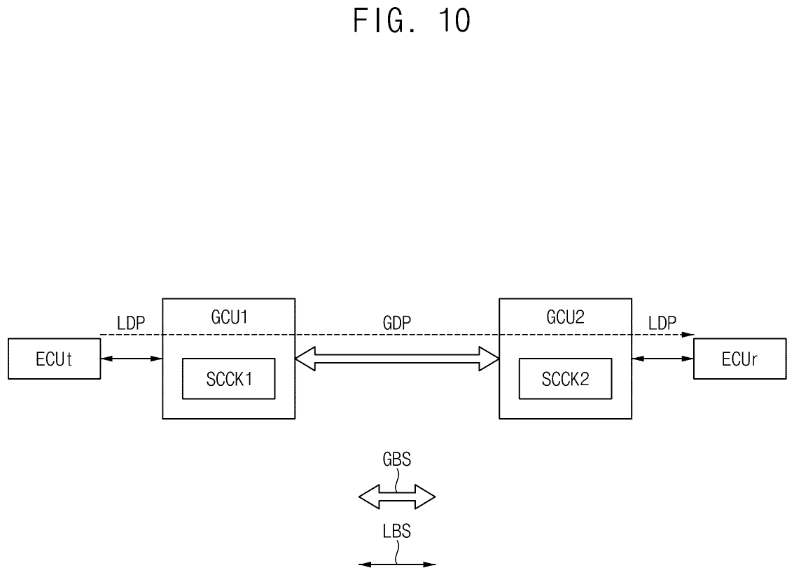

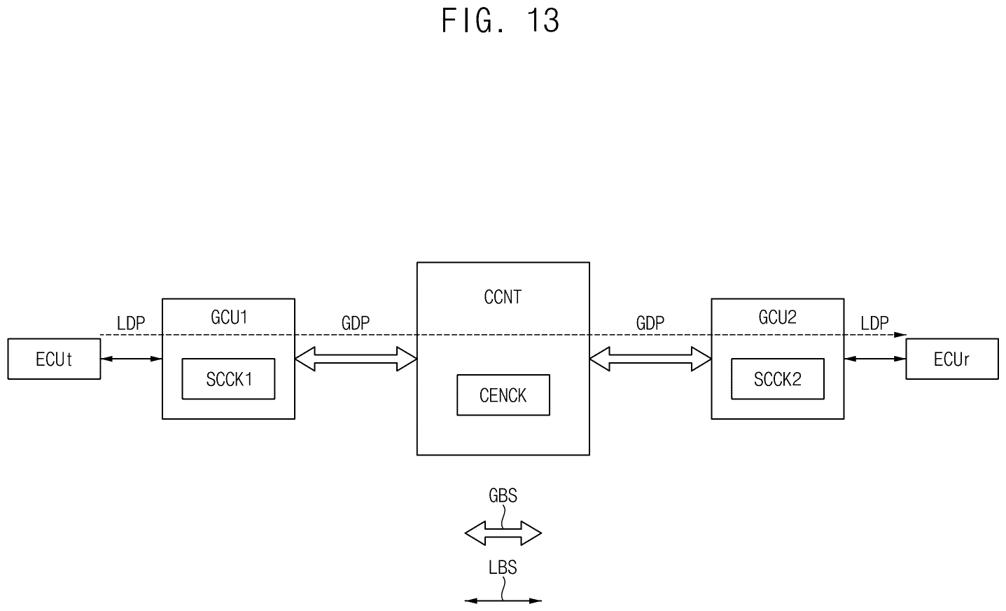

According to example embodiments, the security checker 100 may be included in a Group Control Unit (GCU), as will be described with reference to FIG. 9, FIG. 10, and FIG. 13. Depending on embodiments, the GCU may be a Domain Control Unit (DCU) or a Zone Control Unit (ZCU), as will be described with reference to FIG. 7A, FIG. 7B, and FIG. 7C.

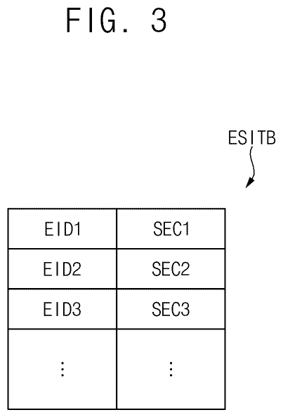

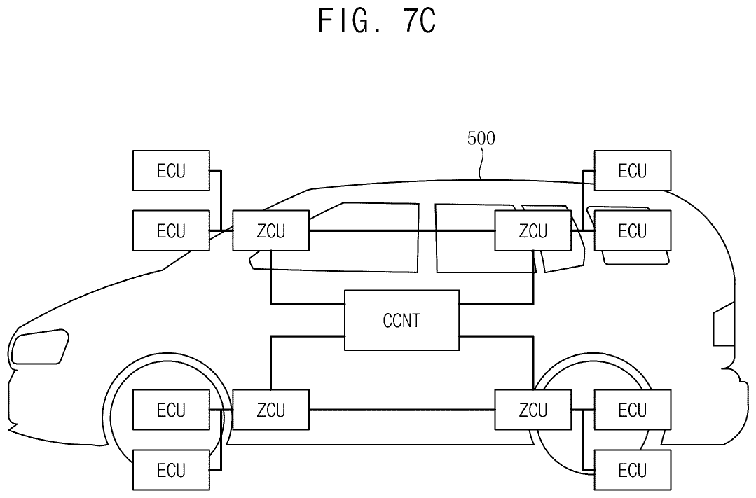

The security checker 100 may include a security information table SECTB, a log storage LOG, and an exception handler EXC. The security checker 100 may store information for security management of the security network system 1000 in the security information table SECTB. The information for security management may include ECU security information as will be further described with reference to FIG. 3, and GCU security information as will be further described with reference to FIG. 8.

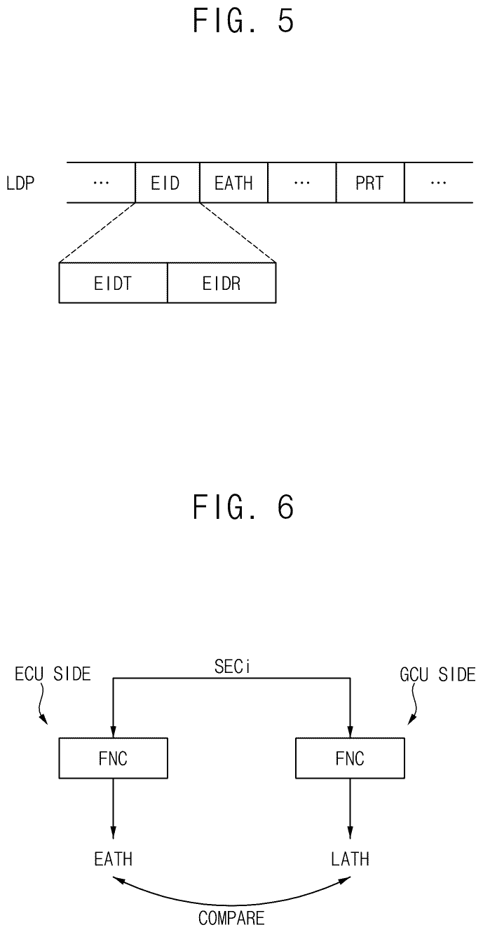

The security checker 100 may perform authentication of local data packets received from the first ECU1 11, the second ECU2 12, and the third ECU3 13 that are connected via a corresponding local bus LBS and may be grouped as part of a same control group, for example, the first control group 30. When the authentication of the local data packet is successful, the security checker 100 may transmit the local data packet to a reception ECU corresponding to a reception ECU identifier (described in connection with FIG. 5). On the other hand, the security checker 100 may stop transmission of the local data packet when the authentication of the local data packet is unsuccessful. For example, the security checker 100 may discard or drop the local data packet when the authentication for the local data packet fails.

The exception handler EXC may store a history of the local data packets in the log storage LOG. The exception handler EXC may store the history of authentication of the local data packets in the log storage LOG. The exception handler EXC may store the history of failed authentication of the local data packets in the log storage LOG. The history stored in the log storage LOG may be analyzed to identify external attacks or malfunctions. Embodiments are not limited thereto, and the history stored in the log storage LOG may be analyzed to identify additional information. In addition, the exception handler EXC may generate an interrupt signal (or a warning signal) when the authentication of the local data packet fails.

The central controller 200 may control the overall operation of the security network system 1000 and may perform operations to control the security network system 1000.

In an example embodiment, the central controller 200 may include a central security checker CENCK. As will be described, the central security checker CENCK may store a plurality of GCU security information respectively corresponding to the plurality of GCUs connected to the central controller 200 via the global bus GBS, and may perform authentication of global data packets received via the global bus GBS based on the plurality of GCU security information.

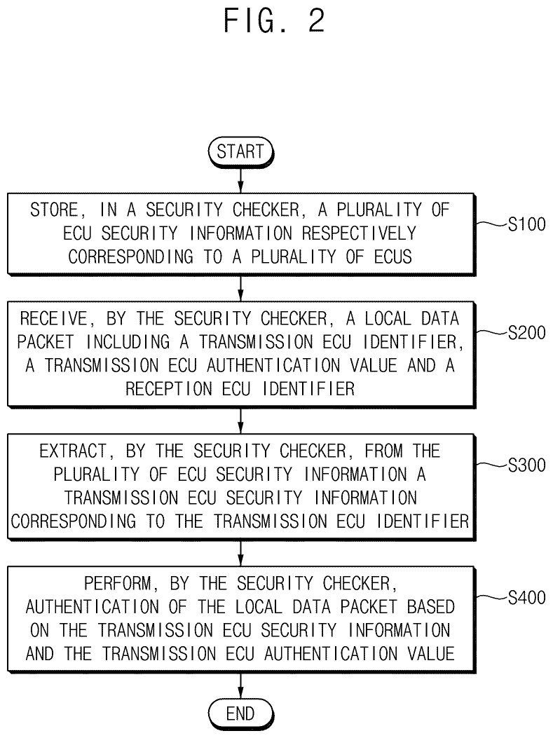

FIG. 2 is a flowchart illustrating a communication method of a security network system according to example embodiments. FIG. 2 illustrates an authentication method that may be performed by a security checker 100 included in the first control group 30 of FIG. 1.

Referring to FIG. 1 and FIG. 2, a plurality of ECU security information respectively corresponding to the plurality of ECUs (first ECU1 11, second ECU2 12, and third ECU3 13) in the first control group 30 may be stored in the security checker 100 (S100).

The security checker 100 may receive a local data packet including a transmission ECU identifier and a transmission ECU authentication value indicative of a transmission ECU among the plurality of ECUs (first ECU1 11, second ECU2 12, and third ECU3 13) (S200).

The security checker 100 may extract the transmission ECU security information corresponding to the transmission ECU identifier from the plurality of ECU security information including the first ECU security information SEC1, the second ECU security information SEC2, and the third ECU security information SEC3 (S300).

The security checker 100 may perform authentication of the local data packet based on the transmission ECU authentication value and the transmission ECU security information (S400).

Hereinafter, a communication method of FIG. 2 will be described in more detail with reference to FIGS. 3 through 6.

FIG. 3 is a diagram illustrating an example embodiment of Electronic Control Unit (ECU) security information in a security network system according to example embodiments.

Referring to FIG. 1, FIG. 2, and FIG. 3, the security checker 100 may include an ECU security information table ESITB. The ECU security information table ESITB of FIG. 3 may correspond to the security information table SECTB of FIG. 1, or may correspond to a portion of the security information table SECTB of FIG. 1.

The security checker 100 may store a plurality of ECU security information including the first ECU security information SEC1, the second ECU security information SEC2, and the third ECU security information SEC3 respectively corresponding to the plurality of ECUs (first ECU1 11, second ECU2 12, and third ECU3 13) included in the corresponding the first control group 30 directly connected to the security checker 100 via the corresponding local bus LBS. The plurality of ECUs (first ECU1 11, second ECU2 12, and third ECU3 13) included in the corresponding the first control group 30 may not be connected via the global bus GBS. In an example embodiment, as shown in FIG. 3, the plurality of ECU security information including the first ECU security information SEC1, the second ECU security information SEC2, and the third ECU security information SEC3 may be stored in the ECU security information table ESITB to be mapped to the plurality of ECU identifiers EID1, EID2 and EID3 of the plurality of ECUs (first ECU1 11, second ECU2 12, and third ECU3 13), respectively. That is, plurality of ECU security information may include a collection of respective ECU security information stored in each ECU of the plurality of ECUs (first ECU1 11, second ECU2 12, and third ECU3 13).

As described with reference to FIG. 1, the plurality of ECUs (first ECU1 11, second ECU2 12, and third ECU3 13) may store the plurality of ECU security information including the first ECU security information SEC1, the second ECU security information SEC2, and the third ECU security information SEC3, respectively. The plurality of ECU security information including the first ECU security information SEC1, the second ECU security information SEC2, and the third ECU security information SEC3 stored in the ECU security information table ESITB of the security checker 100 may be identical to the first ECU security information SEC1 stored in the first ECU 11, the second ECU security information SEC2 stored in the second ECU 12 and the third ECU security information SEC3 stored in the third ECU 13.

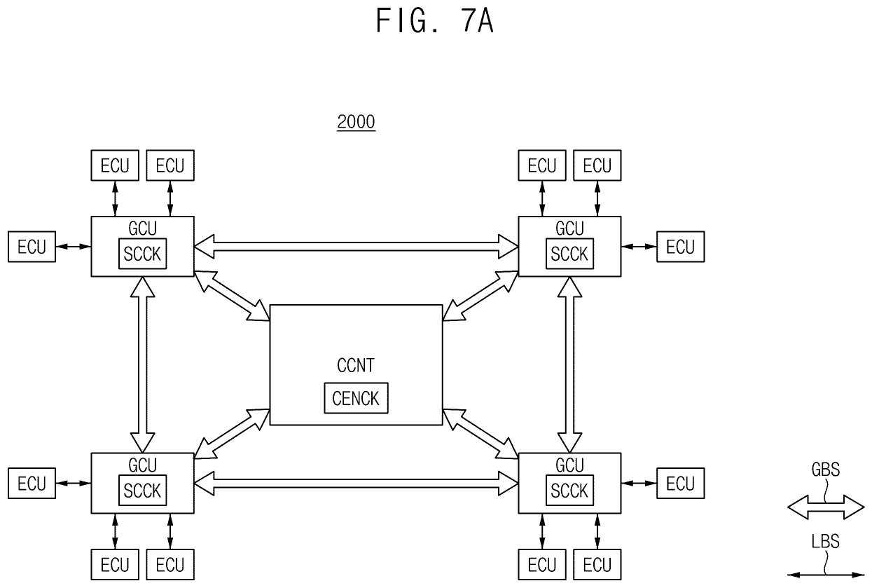

Upon receiving the local data packet, the security checker 100 may extract, from the plurality of ECU security information including the first ECU security information SEC1, the second ECU security information SEC2, and the third ECU security information SEC3 stored in the ECU security information table ESITB, a transmission ECU security information SECi corresponding to a transmission ECU identifier EIDi (i=1, 2, or 3) included in the local data packet. The security checker 100 may perform authentication of the local data packet based on the transmission ECU authentication value included in the local data packet and the extracted transmission ECU security information SECi, as will be described with reference to FIG. 6.

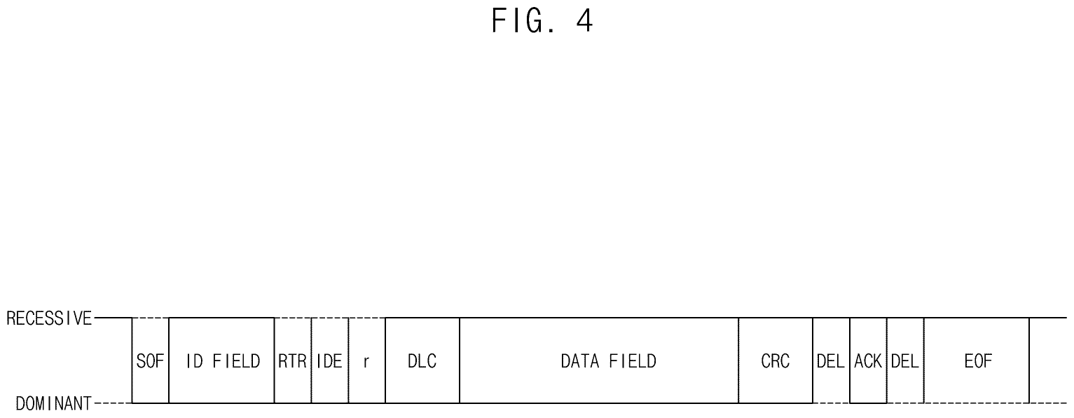

FIG. 4 is a diagram illustrating a format of data packets as prescribed by a Controller Area Network (CAN) protocol. The CAN protocol may use a differential signal with two logic states, called recessive and dominant. Recessive may indicate that a differential voltage is less than a minimum threshold voltage. Dominant may indicate that the differential voltage is greater than this minimum threshold. A dominant state may be achieved by driving a logic 0 onto the bus, and a recessive state may be achieved by driving a logic 1 onto the bus. The concepts of a dominant state and a recessive state may be used in bus arbitration. Bus arbitration may be used to determine which devices requesting bus access will succeed.

FIG. 4 illustrates a standard data frame or data packet as defined by the CAN protocol. In an example embodiment, the local data packets and global data packets may conform to the format of FIG. 4, and thus the local bus LBS and global bus GBS may be buses in accordance with the CAN protocol. Example embodiments are not limited to the CAN protocol, and the local bus LBS and the global bus GBS may carry local data packets and global data packets between nodes according to various protocols. Here, each node may be one of the ECUs, security checkers (or GCUs including security checkers) and the central controller.

Referring to FIG. 4, a data frame comprises each of the following fields: a Start Of Frame (SOF) field, an ID field, a Remote Transmission Request (RTR) field, an Identifier Extension (IDE) field, a reserved bit (r) field, a Data Length Code (DLC) field, a data field, a Cyclic Redundancy Check (CRC) sequence field, a CRC delimiter (DEL) field, an Acknowledgment (ACK) slot field, an ACK delimiter (DEL) field, and an End Of Frame (EOF) field.

The SOF bit may signal a beginning of the data frame. The SOF may include a bit indicative of a dominant level (i.e., a value of 0). For example, the SOF may include one bit. The idle state of buses, such as the local bus LBS and the global bus GBS mentioned above, may be indicative of a recessive level (i.e., a value of 1) and may be changed to dominant by the SOF to indicate the start of transmission of the frame.

The ID field may store an ID (CAN-ID), which may be a value indicates the type of data. The ID field may include 11 bits, for example. The ID field may be designed such that frames with smaller ID values are given higher priority in order to coordinate communication when multiple nodes start transmitting at the same time.

The RTR bit may separate the data frame from the remote frame. For example, the RTR may be a value to identify data frames and remote frames, and may include the dominant 0 bit for data frames. The IDE and the reserved bit (r) may both include a dominant 0 bit. The DLC may be a value that includes 4 bits and represents the length of the data field. The IDE, reserved bit (r), and DLC may be collectively referred to as the control field.

The data field may include up to 64 bits and represents the content of the data being transferred. The length may be adjusted every 8 bits. The specification of the data to be transmitted may not be defined by the CAN protocol, but may be determined by the security network system installed in the vehicle. Therefore, the specification may depend on, for example, the vehicle type or the manufacturer.

The CRC sequence may include 15 bits. The CRC sequence may be calculated from the transmitted values of the SOF, ID field, control field, and data field. The CRC Delimiter (DEL) may be a paragraph symbol that indicates the end of the CRC sequence, including a one-bit recessive. The CRC sequence and the CRC delimiter (DEL) may be collectively referred to as the CRC field.

The ACK slot may include a bit. For example, the ACK slot may include one bit. The transmission node may transmit a data packet by setting the ACK slot to be recessive. The reception node may transmit the ACK slot as being dominant if the reception of the data packet is successfully up to the CRC sequence. Because dominants are prioritized over recessives, if the ACK slot is dominant after transmission, the transmission node may confirm that at least one reception node is successfully listening.

The ACK Delimiter (DEL) may be a paragraph symbol that indicates the end of an ACK including a recessive bit (i.e., a value of 1). The EOF may include a 7-bit recessive and may indicate the end of the data frame.

FIG. 5 is a diagram illustrating a local data packet in a security network system according to example embodiments. In an example embodiment, the local data packet LDP may have the format of a data packet according to the CAN protocol of FIG. 4.

Referring to FIG. 5, the local data packet LDP may include an ECU identifier EID, a transmission ECU authentication value EATH, and priority information PRT. According to example embodiments, the priority information PRT may be omitted. The ECU identifier EID may include a transmission ECU identifier EIDT and a reception ECU identifier EIDR. The identifier EID may be included in the ID field of FIG. 4. The transmission ECU authentication value EATH may be included in the ID field of FIG. 4 or may be included in the data field of FIG. 4. Similarly, the priority information PRT may be included in the ID field of FIG. 4 or may be included in the data field of FIG. 4.

The transmission ECU identifier EIDT may indicate a source ECU or a transmission ECU that generated the local data packet LDP. The reception ECU identifier EIDR may indicate a target ECU or a reception ECU to which the local data packet (LDP) is to be transferred.

The transmission ECU authentication value EATH may be an authentication value generated by the transmission ECU based on the ECU security information stored in the transmission ECU. An authentication method for the local data packet LDP based on the transmission ECU authentication value EATH will be described with reference to FIG. 6.

When the local data packet LDP includes priority information PRT, the security checker 100 may adjust, based on the priority information PRT, the processing order for local data packets and global data packets received by the security checker 100 or a GCU including the security checker 100.

FIG. 6 is a diagram illustrating an example embodiment of authentication in a security network system according to example embodiments.

Referring to FIG. 1 through FIG. 6, at the ECU side, a transmission ECU ECUi (i=1, 2, or 3) may generate a transmission ECU authentication value EATH based on respective ECU security information SECi stored in itself.

The transmission ECU ECUi may generate a local data packet LDP including the transmission ECU identifier EIDT, the transmission ECU authentication value EATH, and the reception ECU identifier EIDR. The transmission ECU ECUi may transmit the local data packet LDP via the local bus LBS to the security checker 100 or a GCU including the security checker 100.

On the GCU side, the security checker 100 may extract the transmission ECU security information SECi corresponding to the transmission ECU identifier EIDi from the plurality of ECU security information including the first ECU security information SEC1, the second ECU security information SEC2, and the third ECU security information SEC3 stored in itself. The security checker 100 may generate a local authentication value LATH based on the extracted transmission ECU security information SECi.

The security checker 100 may perform authentication of the local data packet LDP based on a comparison result of the transmission ECU authentication value EATH included in the local data packet LDP and the local authentication value LATH generated by the security checker 100. When the transmission ECU authentication value EATH and the local authentication value LATH match, the security checker 100 may determine that the received local data packet LDP was generated by the transmission ECU ECUi inside the first control group 30, and the security checker 100 may verify the integrity of the local data packet LDP.

When the authentication of the local data packet is successful, the security checker 100 may transmit the local data packet LDP to the reception ECU corresponding to the reception ECU identifier. On the other hand, the security checker 100 may stop the transmission of the local data packet LDP when the authentication of the local data packet is unsuccessful. For example, the security checker 100 may discard or drop the local data packet LDP if the authentication of the local data packet fails.

As described herein, the exception handler EXC of FIG. 1 may store the history of the failed authentication of the local data packets in the log storage LOG. The history stored in the log storage LOG may be analyzed to identify external attacks or malfunctions. Embodiments are not limited thereto, and the history stored in the log storage LOG may be analyzed to identify additional information. In addition, the exception handler EXC may generate an interrupt signal (or a warning signal) when the authentication of the local data packet fails.

In an example embodiment, the transmission ECU ECUi and the security checker 100 may each use the function FNC to generate the transmission authentication value EATH and the local authentication value LATH. If the ECU security information SECi input to the function FNC is the same, the transmission authentication value EATH and the local authentication value LATH may be the same. The ECU security information SECi may be a unique key (or a private key) that is not publicly disclosed, and the function FNC may be a unique function (or a private function) that is not publicly disclosed.

In an example embodiment, the function FNC may be a hash function. A hash function may be a type of computer cryptography, also known as a message digest function, that generates a pseudorandom number of a fixed length from a given original text, and the generated value is called a “hash value”. The ECU security information SECi may correspond to the original text, and the transmission authentication value EATH and local authentication value LATH may correspond to the hash value.

When transmitting or receiving data over a communication line, the hash value of the data may be obtained at both ends of the path, and by comparing the values at the transmission and reception nodes, it may be possible to determine whether the data has been altered or not during the transmission.

Hash functions are irreversible, one-way functions, such that the original text may not be reconstructed from the hash value. For a one-way function, also known as a trap door function, a result may be relatively simple to obtain from the hash function, and it may be relatively difficult to obtain the hash function from the result. That is, it may be relatively difficult to compromise the hash function. It may also be relatively difficult to create other data with the same hash value. According to example embodiments, these properties of hash functions may be utilized to authenticate the integrity of local data packets LDPs delivered over the local bus LBS.

According to example embodiments, a security checker may be deployed between the automotive networks, which check the security of the communications between ECUs and relays the communications. In this case, each ECU may not need to know the security information of other ECUs, and security may be improved. In an example embodiment in which the security checker checks the security of the communications between ECUs and relays the communications, the network of ECUs may be scaled by updating the security checker. is the security checker may also be adaptable to a centralized architecture, which is a potential next generation structure in vehicles.

A security network system and a communication method of the security network system according to example embodiments may enhance communication security in a vehicle by reducing security vulnerabilities the security information of other ECUs may be controlled by a security checker. For example, one or more of the ECUs may not store or have access to the security information of other ECUs. The enhanced communication security may prevent or inhibit malicious attacks and may enhance the reliability of the vehicle.

Furthermore, a security network system and a communication method of the security network system according to example embodiments may be advantageous in terms of scalability and may be adapted to a centralized structure, as the security checker may be easily updated as the network is updated. For example, the security checker may be updated as the network is expanded to include an additional ECU, contracted by removing an ECU, or an ECU is replaced. According to an embodiment, one or more of the ECUs may not need to be updated.

FIG. 7A, FIG. 7B and FIG. 7C are diagrams illustrating a security network system according to example embodiments.

Referring to FIG. 7A, a security network system 2000 may include a central controller, a plurality of GCUs, and a plurality of ECUs.

The plurality of ECUs may be interspersed in a device, such as a vehicle, to which the security network system 2000 is applied. The plurality of ECUs may be appropriately grouped such that one or more of the ECUs may be connected to a corresponding GCU via a corresponding local bus LBS. The plurality of GCUs and the central controller CCNT may be connected to each other via a global bus GBS.

The GCUs may each include a security checker SCCK as described above, and the central controller CCNT may include a central security checker CENCK.

As will be described with reference to FIG. 9, the security checker SCCK included in the GCU may perform authentication of local data packets LDPs delivered over the local bus LBS from ECUs connected to the security checker SCCK. Further, as will be described with reference to FIG. 10, the security checker SCCK included in the GCU may authenticate global data packets GDP delivered over the global bus GBS from other GCUs and the central controller CCNT. As will be described with reference to FIG. 13, the central security checker CENCK included in the central controller CCNT may authenticate global data packets GDPs delivered over the global bus GBS from GCUs.

FIG. 7B and FIG. 7C illustrate embodiments of a security network system mounted on a vehicle 500 and having a centralized architecture.

The security network system according to example embodiments may be implemented in a domain-oriented structure as shown in FIG. 7B, or may be implemented in a zone-oriented structure as shown in FIG. 7C. For example, the GCU may be a domain control unit DCU as shown in FIG. 7B, or a zone control unit ZCU as shown in FIG. 7C. Although not shown, a security network system according to example embodiments may be implemented with a combination of a domain-oriented structure and a zone-oriented structure in which the security network system may have a hierarchical structure of a plurality of ZCUs and a plurality of DCUs.

The ECUs may be grouped together and controlled by a DCU. Domain control may divide systems of the vehicle according to similar functions. For example, domain control may group the systems according to, for example, steering, braking, and lighting. Integrating the semiconductor circuits used in ECUs may simplify the computing structure and increase efficiency.

Zone control is a way of controlling a vehicle by dividing it into zones, or physical regions. Each ZCU may be connected to ECUs that are part of a same physical zone. For example, a vehicle may be divided into a left front zone, a left rear zone, a right front zone, and a right rear zone, and a single ZCU may manage the functions for each zone. A central controller (e.g., a central processing unit (CPU)) may manage the ZCUs in an integrated manner, and by increasing the performance of this central controller, the performance of the vehicle itself may be improved.

The ZCU may have a relatively simple internal structure as compared to the DCU concept, which may organize the semiconductor circuits that control the vehicle's behavior by function. Fewer semiconductor circuits may handle multiple functions, reducing the time and cost of upgrading the system and reducing the weight of the electronics.

The ZCU concept may be applied to various functions. An example zone may be applied to “body control” functions. Body control may be a general term for actions such as opening and closing windows or folding and unfolding rear mirrors. The ability to adjust the seat position may also be included in the body control zone. By their nature, body controls may occur in any part of the vehicle, e.g., the front, rear, left, or right. For example, the rearview mirror may be located at the front of the car, the trunk may be located at the back of the car, and the seat may be located in the middle of the car. “Motion control” functions, which may be related to vehicle driving, such as steering, brakes, or dampers., may also have this characteristic of being located in any part of the vehicle.

By utilizing the security network system according to example embodiments, communication security inside the vehicle may be enhanced to prevent or inhibit malfunctions and malicious attacks. The enhancement of communication security may further facilitate the development of centralized vehicle control using DCUs and/or ZCUs.

FIG. 8 is a diagram illustrating an example embodiment of Group Control Unit (GCU) security information in a security network system according to example embodiments.

Referring to FIG. 1 and FIG. 8, the security checker 100 may include a GCU security information table GSITB. The ECU security information table ESITB of FIG. 3 and the GCU security information table GSITB of FIG. 8 may correspond to the security information table SECTB of FIG. 1 or may be a subset of the security information table SECTB.

The plurality of GCUs, including the first control group 30, the second control group 31, the third control group 32 and the fourth control group 33, included in the security network system 1000 may each include a security checker (SCCK) 100. Each security checker SCCK may include a plurality of GCU security information respectively corresponding to the plurality of GCUs including the first to fourth control groups 30, 31, 32 and 33. In an example embodiment, as shown in FIG. 8, the plurality of GCU security information including first GCU security information GSEC1, second GCU security information GSEC2, and third GCU security information GSEC3, may be stored in a GCU security information table GSITB where the plurality of GCU security information is mapped to the plurality of GCU identifiers including a first GCU identifier GID1, a second GCU identifier GID2, and a third GCU identifier GID3 of the plurality of GCUs included in the first to third control groups 30, 31 and 32, respectively. Further, the GCU security information table GSITB may store ECU identifiers of the ECUs that are associated with the plurality of GCUs corresponding to the plurality of GCU identifiers including the first to third GCU identifiers GID1, GID2 and GID3, respectively. In the example of FIG. 8, the GCU of the first control group 30 may have three ECUs connected to it and ECU identifiers including a first ECU identifier EID1, a second ECU identifier EID2, and a third ECU identifier EID3 corresponding to the three ECUs may be stored in the GCU security information table GSITB, the GCU of the second control group 31 may have two ECUs connected to it, and ECU identifiers EID4 and EID5 corresponding to the two ECUs may be stored in the GCU security information table GSITB, and the GCU of the third control group 32 may have four ECUs connected to it, and ECU identifiers EID6, EID7, EID8 and EID8 may be stored in the GCU security information table GSITB.

FIG. 9 is a diagram illustrating an intra-group communication and an inter-group communication in a security network system according to example embodiments.

Referring to FIG. 9, when a transmission ECU ECUt that transmits a local data packet LDP and a reception ECU ECUr that receives the local data packet LDP are commonly connected to a same GCU and authentication of the local data packet LDP is successful, the GCU may transmit the local data packet LDP to the reception ECU ECUr. Such communication within a control group may be referred to as intra-group communication. In the case of intra-group communication, authentication of the local data packets LDPs may be performed. The authentication of the local data packet LDP may be performed as described with reference to FIG. 1 through FIG. 6.

On the other hand, when a reception GCU to which the reception ECU corresponding to the reception ECU identifier EIDT is connected and a transmission GCU to which the transmission ECU corresponding to the transmission ECU identifier EIDR is connected are different from each other, and the authentication of the local data packet LDP is successful by the transmission GCU, the transmission GCU may generate a global data packet GDP and transmit the global data packet GDP via the global bus GBS to the reception GCU to which the reception ECU is connected. Such communication between different control groups may be referred to as inter-group communication. In the case of inter-group communication, authentication of the global data packets GDP may be performed as well as authentication of the local data packets LDP.

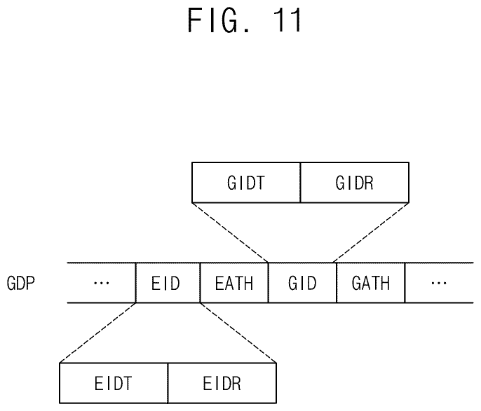

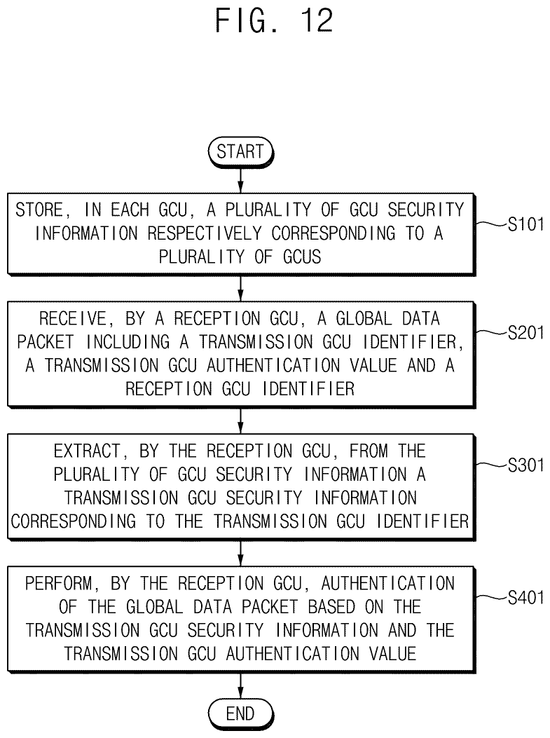

Hereinafter, global data packets GDP for inter-group communication and authentication of the global data packets GDP will be described with reference to FIG. 10, FIG. 11, and FIG. 12.

FIG. 10 is a diagram illustrating an inter-group communication in a security network system according to example embodiments.

Referring to FIG. 10, a transmission ECU ECUt may be connected to a first GCU GCU1 via a first local bus LBS, and a reception ECU ECUt may be connected to a second GCU GCU2 via a second local bus LBS. In this case, the first GCU GCU1 corresponds to the transmission GCU and the second GCU GCU2 corresponds to the reception GCU. The transmission GCU GCU1 and reception GCU GCU2 may be connected to each other via a global bus GBS.

The security checker SCCK1 included in the transmission GCU GCU1 may include a GCU security information table GSITB as described with reference to FIG. 8. The security checker SCCK1 included in the transmission GCU GCU1 may perform authentication of the local data packet LDP as described with reference to FIG. 1 through FIG. 6. When the security checker SCCK1 included in the transmission GCU GCU1 successfully authenticates the local data packet LDP, the transmission GCU GCU1 may generate a global data packet GDP based on a plurality of GCU security information stored in the GCU security information table GSITB.

FIG. 11 is a diagram illustrating a global data packet in a security network system according to example embodiments. In an example embodiment, the global data packet GDP may have the format of a data packet according to the CAN protocol of FIG. 4.

Referring to FIG. 11, a global data packet GDP may include an ECU identifier EID, a transmission ECU authentication value EATH, a GCU identifier GID, and a transmission GCU authentication value GATH. As described with reference to FIG. 5, the global data packet GDP may further include priority information PRT. The ECU identifier EID may include a transmission ECU identifier EIDT and a reception ECU identifier EIDR. The GCU identifier GID may include a transmission GCU identifier GIDT and a reception GCU identifier GIDR. The GCU identifier GID and the transmission GCU authentication value GATH may be included in the ID field and/or the data field of FIG. 4.

Referring to FIG. 10 and FIG. 11, the transmission ECU identifier EIDT may indicate the transmission ECU ECUt that generated the local data packet LDP, and the reception ECU identifier EIDR may indicate the reception ECU ECUr to which the local data packet LDP is to be transferred.

The transmission GCU identifier GIDT may indicate the transmission GCU GCU1 to which the transmission ECU ECUt that generated the local data packet LDP is connected, and the reception GCU identifier GIDR may indicate the reception GCU GCU2 to which the reception ECU ECUr to which the local data packet LDP will be transferred is connected.

The transmission ECU authentication value EATH may be an authentication value generated by the transmission ECU ECUt based on the ECU security information stored in the transmission ECU ECUt. An authentication method according to an embodiment for the local data packet LDP based on the transmission ECU authentication value EATH is described with reference to FIG. 6.

The transmission GCU authentication value GATH may be an authentication value generated by the transmission GCU GCU1 based on the GCU security information stored in the transmission GCU GCU1. An authentication method according to an embodiment for the global data packets GDP based on the transmission GCU authentication value EATH may be performed by the reception GCU GCU2 in a similar way to an authentication method for local data packets LDP. An authentication method for the global data packet (GDP) will be described with reference to FIG. 12.

As such, the transmission GCU GCU1 may generate the global data packet GDP by adding the transmission GCU identifier GIDT corresponding to the transmission GCU GCU1, the transmission GCU authentication value GATH, and the reception GCU identifier GIDR corresponding to the reception GCU GCU2 to the local data packet LDP. The transmission GCU GCU1 may transmit the global data packet GDP to the reception GCU GCU2 via the global bus GBS.

FIG. 12 is a flowchart illustrating a communication method of a security network system according to example embodiments. Hereinafter, a method of authenticating a global data packet GDP performed by a security checker included in a reception GCU is described referring to FIG. 12. Authentication for the global data packet GDP may be performed similarly to authentication for the local data packet LDP as described with reference to FIG. 1 through FIG. 6, and repetitive descriptions thereof may be omitted.

Referring to FIG. 12, a plurality of GCU security information respectively corresponding to a plurality of GCUs may be stored in each GCU (S101). For example, a security checker included in each of the plurality of GCUs may store the plurality of GCU security information corresponding to each of the plurality of GCUs. As described with reference to FIG. 8, the plurality of GCU security information including first through third GCU security information GSEC1, GSEC2 and GSEC3 may be stored in a GCU security information table GSITB that maps to the plurality of GCU identifiers including the first to third GCU identifiers GID1, GID2 and GID3 of the plurality of GCUs respectively included in the control groups.

As described with reference to FIG. 10 and FIG. 11, the reception GCU GCU2 may receive a global data packet GDP including a transmission GCU identifier GIDT and a transmission GCU authentication value GATH indicating the transmission GCU (S201). As shown in FIG. 12, the global data packet GDP may also include a reception GCU identifier identifying the reception GCU GCU2. As described herein, the transmission GCU GCU1 may generate the transmission GCU authentication value GATH based on the first GCU security information GSEC1 corresponding to the transmission GCU GCU1 among the plurality of GCU security information including first through third GCU security information GSEC1, GSEC2 and GSEC3 stored in the transmission GCU GCU1.

The security checker SCCK2 included in the reception GCU GCU2 may, upon receiving the global data packet GDP, extract the transmission GCU security information (i.e., the first GCU security information GSEC1 in the example) corresponding to the transmission GCU identifier GIDT from the plurality of GCU security information including first through third GCU security information GSEC1, GSEC2 and GSEC3 stored in the reception GCU GCU2 (S301).

The security checker SCCK2 included in the reception GCU GCU2 may authenticate the global data packet GDP based on the transmission GCU authentication value GATH included in the global data packet GDP and the extracted transmission GCU security information (i.e., the first GCU security information GSEC1 in the example) (S401). The security checker SCCK2 included in the reception GCU GCU2 may authenticate the global data packet GDP as described with reference to FIG. 6.

The security checker SCCK2 included in the reception GCU GCU2 may generate a global authentication value based on the extracted transmission GCU security information (i.e., the first GCU security information GSEC1 in the example), and perform authentication of the global data packet GDP based on a comparison result of the transmission GCU authentication value GATH included in the global data packet GDP and the global authentication value generated by the reception GCU GCU2. The security checker SCCK2 included in the reception GCU GCU2 may determine that the received global data packet GDP is generated by the transmission GCU GCU1 inside the security network system when the transmission GCU authentication value GATH and the global authentication value match, and may verify the integrity of the global data packet GDP.

The security checker SCCK2 included in the reception GCU GCU2 may, when the authentication of the global data packet GDP is successful, restore the local data packet LDP from the global data packet GDP and transmit the restored local data packet LDP to the reception ECU ECUr corresponding to the reception ECU identifier EIDr. In an example embodiment, the reception GCU GCU2 may omit authentication of subsequent global data packets transmitted from the transmission GCU GCU1 for an effective time interval when authentication of the first global data packet GDP transmitted from the transmission GCU GCU1 is successful.

According to an embodiment, the effective time interval may be a predetermined effective time interval, for example, measured in time. According to an embodiment, the effective time interval may be event based, for example, ending or being reset upon a turn off event of the vehicle. According to an embodiment, the effective time interval may be usage based, for example, ending or being reset upon a number of subsequent global data packets.

On the other hand, the security checker SCCK2 included in the reception GCU GCU2 may stop the transmission of the local data packet LDP when the authentication of the global data packet GDP is unsuccessful. For example, the security checker SCCK2 included in the reception GCU GCU2 may discard or drop the local data packet LDP when the authentication of the global data packet GDP fails.

In this way, authentication of the local data packet LDP by the transmission GCU GCU1 and authentication of the global data packet GDP by the reception GCU GCU2 may be performed redundantly to further enhance security within the security network system.

FIG. 13 is a diagram illustrating an inter-group communication in a security network system according to example embodiments.

Referring to FIG. 13, a transmission ECU ECUt may be connected to a first GCU GCU1 via a first local bus LBS, and a reception ECU ECUt may be connected to a second GCU GCU2 via a second local bus LBS. In this case, the first GCU GCU1 corresponds to a transmission GCU and the second GCU GCU2 corresponds to the reception GCU. The transmission GCU GCU1 and reception GCU GCU2 may be connected to the central controller CCNT via the global bus GBS.

The inter-group communication illustrated in FIG. 13 is similar to the inter-group communication of FIG. 10 and repetitive descriptions thereof may be omitted. Further, the transmission of global data packets GDP between the transmission GCU GCU1 and reception GCU GCU2 may be mediated by the central controller CCNT.

The central security checker CENCK included in the central controller CCNT may include a GCU security information table GSITB as described with reference to FIG. 8.

Upon receiving a global data packet GDP from the transmission GCU GCU1, the central security checker CENCK may extract a transmission GCU security information (for example, the first GCU security information GSEC1) corresponding to a transmission GCU identifier GIDT from among a plurality of GCU security information including first through third GCU security information GSEC1, GSEC2 and GSEC3 stored in the central controller CCNT.

The central security checker CENCK may perform authentication of the global data packet GDP based on the transmission GCU authentication value GATH included in the global data packet GDP and the extracted transmission GCU security information (i.e., the first GCU security information GSEC1 in the example). The central controller CCNT may perform authentication of the global data packet GDP similarly as described with reference to FIG. 6.

The central security checker CENCK may generate a global authentication value based on the extracted transmission GCU security information (i.e., the first GCU security information GSEC1 in the example), and perform authentication of the global data packet GDP based on a comparison result of the transmission GCU authentication value GATH included in the global data packet GDP and the global authentication value generated by the central security checker CENCK. The central security checker CENCK may determine that the received global data packet GDP is generated by the transmission GCU GCU1 inside the security network system if the transmission GCU authentication value GATH and the global authentication value match, and may verify the integrity of the global data packet GDP.

The central security checker CENCK may transmit the global data packet GDP to the reception GCU GCU2 when the authentication of the global data packet GDP is successful. The reception GCU GCU2 may perform authentication of the received global data packet GDP as described with reference to FIG. 12.

In an example embodiment, the central security checker CENCK may omit authentication of subsequent global data packets transmitted from the transmission GCU GCU1 for an effective time interval when authentication of the first global data packet GDP transmitted from the transmission GCU GCU1 is successful.

On the other hand, the central security checker CENCK may stop the transmission of the global data packet GDP when the authentication of the global data packet GDP is unsuccessful. For example, the central security checker CENCK may discard or drop the global data packet GDP when the authentication for the global data packet GDP fails.

In this way, the security inside the security network system may be further enhanced by redundantly performing authentication of the local data packet LDP by the transmission GCU GCU1, authentication of the global data packet GDP by the central security checker CENCK, and authentication of the global data packet GDP by the reception GCU GCU2.

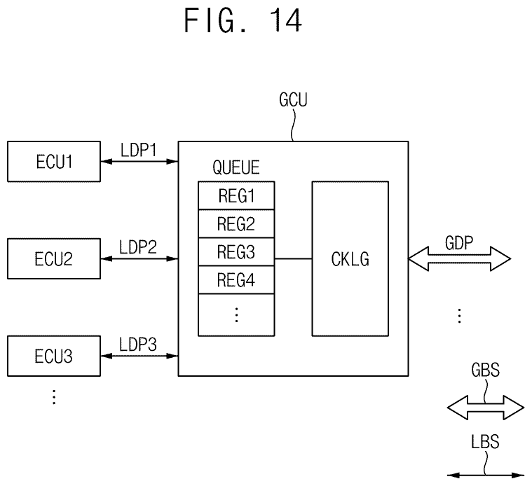

FIG. 14 is a diagram illustrating an example embodiment of a GCU included in a security network system according to example embodiments.

Referring to FIG. 14, the GCU may include a queuing circuit and a control logic circuit CKLG. The queuing circuit may include registers REG1 through REG4 that store incoming local data packets. The number of registers REG1 through REG4 may be varied. A security checker according to an embodiment may be included in a control logic circuit CKLG.

The GCU may receive local data packets LDP1, LDP2 and LDP3 from the plurality of ECUs ECU1, ECU2 and ECU3 and store each received local data packet in each of the registers REG1 through REG4 on a packet-by-packet basis.

In an example embodiment, the local data packets LDP1, LDP2 and LDP3 may include priority information PRT as described with reference to FIG. 5. The security checker included in the control logic circuit CKLG may adjust the processing order of the incoming local data packets LDP1, LDP2 and LDP3 based on the priority information PRT. For example, a local data packet LDP1 transmitted from ECU1 may have a higher priority than a local data packet LDP2 transmitted from ECU2. In this case, the security checker may process the local data packet LDP1 before the local data packet LDP2, even if the local data packet LDP1 is received later than the local data packet LDP2.

In an example embodiment, the local data packets LDP1, LDP2 and LDP3 may not include priority information PRT. In this case, the security checker may process the incoming local data packets LDP1, LDP2 and LDP3 in a first-in first-out (FIFO) scheme, for example.

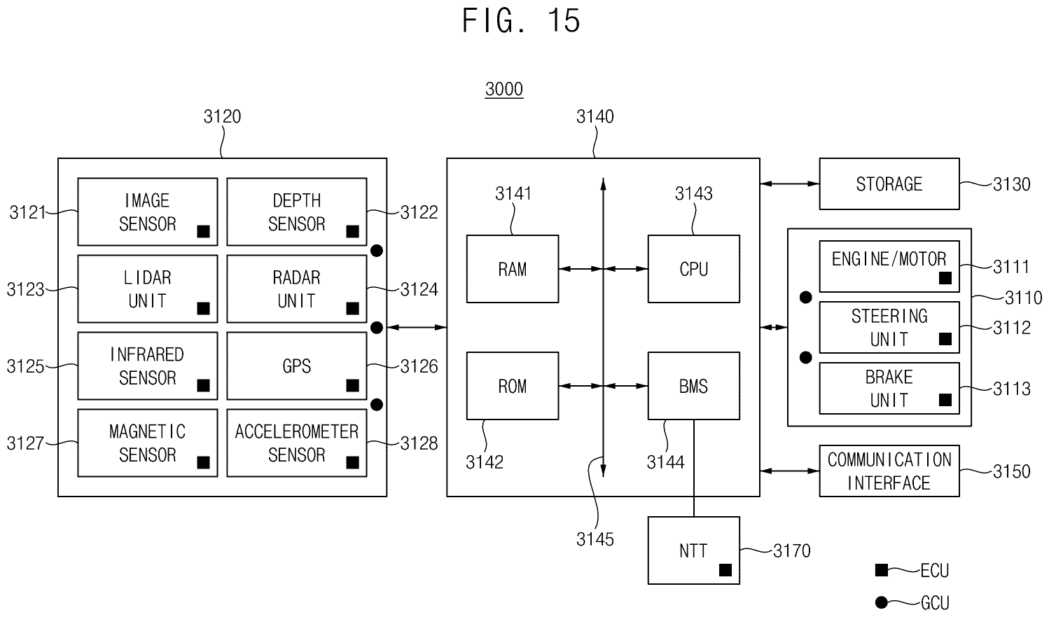

FIG. 15 is a block diagram illustrating an autonomous driving device including a security network system according to example embodiments.

Referring to FIG. 15, an autonomous driving device 3000 may include a driver (e.g., including circuitry) 3110, a sensor 3120, a storage 3130, a controller (e.g., including processing circuitry) 3140, and a communication interface 3150. In an example embodiment, the autonomous driving device 3000 may be an electric car including a high-capacity battery (NTT) 3170.

The driver 3110 may, for example, be configured for driving the autonomous driving device 3000 and may include various circuitry. In a case that the autonomous driving device 3000 is implemented as a vehicle, the driver 3110 may include various circuitry and/or components, such as, for example, an engine/motor 3111, a steering unit 3112, a brake unit 3113, and the like.

The engine/motor 3111 may include one or more of an internal combustion engine, an electric motor, a steam locomotive, or a Stirling engine. For example, in a case that the autonomous driving device 3000 is a gas-electric hybrid car, the engine/motor 3111 may be a gasoline engine and an electric motor. For example, the engine/motor 3111 may be configured to supply energy for the autonomous driving device 3000 to drive on a predetermined driving route.

The steering unit 3112 may be any combination of mechanisms included to control a direction of the autonomous driving device 3000. For example, when an obstacle is recognized while the autonomous driving device 3000 is driving, the steering unit 3112 may change the direction of the autonomous driving device 3000. In a case that the autonomous driving device 3000 is a vehicle, the steering unit 3112 may be configured to turn the steering wheel clockwise or counterclockwise, and change the direction of the autonomous driving device 3000 accordingly.

The brake unit 3113 may be any combination of mechanisms included to decelerate the autonomous driving device 3000. For example, the brake unit may use friction and/or electric braking to reduce a speed of wheels/tires. When an obstacle is recognized while the autonomous driving device 3000 is driving, the brake unit 3113 may be configured to decelerate or slow the autonomous driving device 3000.

The driver 3110 may be an autonomous driving device 3000 driving or traveling on the ground, but embodiments are not limited thereto. The driver 3110 may include a flight propulsion unit, a propeller, or wings, and may include a variety of vessel propulsion devices.

The sensor 3120 may include a number of sensors configured to sense information relating to a surrounding environment of the autonomous driving device 3000. For example, the sensor 3120 may include at least one of an image sensor 3121, a depth camera 3122, a LIDAR unit 3123, a RADAR unit 3124, an infrared sensor 3125, a Global Positioning System (GPS) 3126, a magnetic sensor 3127, and/or an accelerometer sensor 3128.

The image sensor 3121 may be configured to capture an image of, or other data related to an external object located outside of the autonomous driving device 3000. Captured image or other data related to the external device may be used as data for changing at least one of a velocity or direction of the autonomous driving device 3000. The image sensor 3121 may include a sensor of various types, such as a charge coupled device (CCD) and a complementary metal oxide semiconductor (CMOS). In addition, the depth camera 3122 may acquire a depth for determining a distance between the autonomous driving device 3000 and an external object.

The LIDAR unit 3123, the RADAR unit 3124, and the infrared sensor 3125 may each include a sensor configured to output a particular signal and sense external objects in an environment in which the autonomous driving device 3000 is located. For example, the LIDAR unit 3123 may include a laser light source and/or laser scanner configured to radiate a laser, and a detector configured to detect reflection of the laser. The RADAR unit 3124 may be a sensor configured to sense objects in the environment in which the autonomous driving device 3000 is located, using a wireless signal. In addition, the RADAR unit 3124 may be configured to sense speeds and/or directions of the objects. The infrared sensor 3125 may be a sensor configured to sense external objects in an environment in which the autonomous driving device 3000 is located using a light of a wavelength of an infrared area.

The GPS 3126, the magnetic sensor 3127, and the accelerometer sensor 3128 may each include a sensor configured to acquire information relating to a velocity, direction, location, etc. of the autonomous driving device 3000. For example, information relating to a current state of the autonomous driving device 3000 may be acquired and a possibility of collision with an external object, etc. may be identified and/or estimated. The GPS 3126 may be configured to receive a location of the autonomous driving device 3000 as longitude/latitude and altitude data through a satellite, and the magnetic sensor 3127 and the accelerometer sensor 3128 may be configured to identify the current state of the autonomous driving device 3000 according to momentum of the autonomous driving device 3000.

The storage 3130 may be configured to store data, which may enable the controller 3140 to execute various processing. For example, the storage 3130 may be realized as an internal memory such as ROM, RAM, or the like included in the controller 3140, and may be realized as a separate memory from the controller 3140. In this case, the storage 3130 may be realized in the form of a memory embedded in the autonomous driving device 3000, or may be realized in the form of a memory that may be detachable from the autonomous driving device 3000 according to the usage of data storage. For example, data for driving the autonomous driving device 3000 may be stored in a memory embedded in the autonomous driving device 3000, and data for an extension function of the autonomous driving device 3000 may be stored in a memory that may be detached from the autonomous driving device 3000. The memory embedded in the autonomous driving device 3000 may be realized in the form of a nonvolatile memory, volatile memory, flash memory, hard disk drive (HDD), solid state drive (SDD), or the like, and the memory that may be detached from the autonomous driving device 3000 may be realized in the form of a memory card (e.g., micro SD card, USB memory), an external memory that is connectable to a USB port (e.g. USB memory), and the like.

The communication interface 3150 may include various communication circuitry and may be configured to facilitate communication between the autonomous driving device 3000 and an external device. For example, the communication interface 3150 may transmit and receive driving information of the autonomous driving device 3000 to and from the external device. For example, the communication interface 3150 may be configured to perform communication through various communication methods such as an Infrared (IR) communication, a Wireless Fidelity (WI-FI), Bluetooth, Zigbee, Beacon, near field communication (NFC), WAN, Ethernet, IEEE 1394, HDMI, USB, MHL, AES/EBU, Optical, Coaxial, or the like. In some embodiments, the communication interface 3150 may be configured to communicate driving information through a server (not illustrated).

The controller 3140 may include a random access memory (RAM) 3141, a read only memory (ROM) 3142, a central processing unit (CPU) 3143, a battery management system (BMS) 3144 and a bus 3145. The RAM 3141, the ROM 3142, the CPU 3143 and the BMS 3144 may be connected to each other through the bus 3155. The controller 3140 may be implemented as a system on chip (SoC).

The RAM 3141 may be a memory for reading, from the storage 3130, various instructions related to driving of the autonomous driving device 3000. The ROM 3142 may store a set of instructions for system booting. In response to a turn on command being input to the autonomous driving device 3000 and power being supplied, the CPU 3143 may copy an operating system (OS) stored in the storage 3130 into the RAM 3141 according to a command stored in the ROM 3142, and boot the system by executing the OS. When booting is completed, the CPU 3143 may perform various operations by copying various types of application programs stored in the storage 3130 into the RAM 3141 and executing the application programs copied into the RAM 3141. The controller 3140 may perform various operations using a module stored in the storage 3130.

As described above, the security network system and the communication method of the security network system according to example embodiments may enhance communication security in a vehicle by reducing security vulnerabilities because each ECU does not need to know the security information of other ECUs. The enhanced communication security may prevent or inhibit malicious attacks and may enhance the reliability of the vehicle.

Furthermore, the security network system and the communication method of the security network system according to example embodiments may be advantageous in terms of scalability and may be adapted to a centralized architecture, as only the security checker may need to be updated when the network is updated.

Aspects of this disclosure may be applied to any electronic devices and systems including a nonvolatile memory device. For example, the described processes, devices, and systems may be applied to systems such as a memory card, a solid state drive (SSD), an embedded multimedia card (eMMC), a universal flash storage (UFS), a mobile phone, a smart phone, a personal digital assistant (PDA), a portable multimedia player (PMP), a digital camera, a camcorder, a personal computer (PC), a server computer, a workstation, a laptop computer, a digital TV, a set-top box, a portable game console, a navigation system, a wearable device, an internet of things (IoT) device, an internet of everything (IoE) device, an e-book, a virtual reality (VR) device, an augmented reality (AR) device, a server system, an automotive driving system, etc.

The foregoing is illustrative of some implementations and is not to be construed as limiting thereof. Although a few some implementations have been described, those skilled in the art will readily appreciate that many modifications are possible in the some implementations without materially departing from the scope of this disclosure.

What is claimed is:

1. A security network system for a vehicle, comprising:
a plurality of electronic control units (ECUs);
a global bus; and
a plurality of group control units (GCUs) connected to the global bus, wherein each GCU of the plurality of GCUs is connected to at least one ECU of the plurality of ECUs, wherein a transmission ECU of the plurality of ECUs is configured to transmit a local data packet including a transmission ECU identifier and a transmission ECU authentication value to a GCU connected to the transmission ECU,
wherein the GCU includes a first security checker configured to:
store a plurality of ECU security information respectively corresponding to the plurality of ECUs;
upon receipt of the local data packet, extract from the plurality of ECU security information a transmission ECU security information corresponding to the transmission ECU identifier included in the local data packet; and
perform authentication of the local data packet based on the transmission ECU security information and the transmission ECU authentication value included in the local data packet.

2. The security network system of claim 1, wherein the transmission ECU is configured to generate the transmission ECU authentication value based on the plurality of ECU security information.

3. The security network system of claim 2, wherein the plurality of ECU security information stored in the first security checker is a collection of respective ECU security information stored in each ECU of the plurality of ECUs.

4. The security network system of claim 1, wherein the first security checker is configured to generate a local authentication value based on the transmission ECU security information corresponding to the transmission ECU identifier and perform the authentication of the local data packet based on a comparison result of the transmission ECU authentication value and the local authentication value, and
wherein the GCU is configured to transmit the local data packet to a reception ECU corresponding to a reception ECU identifier included in the local data packet when authentication of the local data packet is successful and stop transmission of the local data packet when authentication of the local data packet is unsuccessful.

5. The security network system of claim 1, wherein, the GCU is configured to transmit the local data packet to a reception ECU when the transmission ECU corresponding to the transmission ECU identifier and the reception ECU corresponding to a reception ECU identifier included in the local data packet are commonly connected to the GCU and authentication of the local data packet is successful.

6. The security network system of claim 1, wherein the GCU to which the transmission ECU corresponding to the transmission ECU identifier is connected is a transmission GCU configured to:
generate a global data packet by adding a transmission GCU identifier corresponding to the transmission GCU, a transmission GCU authentication value, and a reception GCU identifier corresponding to a reception GCU to which a reception ECU corresponding to a reception ECU identifier included in the local data packet is connected is different from the transmission GCU and authentication of the local data packet is successful; and
transmit the global data packet to the reception GCU via the global bus.

7. The security network system of claim 6, wherein the reception GCU includes a second security checker, and the second security checker is configured to store a plurality of GCU security information respectively corresponding to the plurality of GCUs, and
wherein the second security checker included in the reception GCU is further configured to:
upon receiving the global data packet, extract from the plurality of GCU security information a transmission GCU security information corresponding to the transmission GCU identifier; and
perform authentication of the global data packet based on the transmission GCU authentication value and the transmission GCU security information.

8. The security network system of claim 7, wherein the transmission GCU is configured to generate the transmission GCU authentication value based on a GCU security information corresponding to the transmission GCU among the plurality of GCU security information stored in the transmission GCU.

9. The security network system of claim 7, wherein the second security checker included in the reception GCU is configured to generate a global authentication value based on the transmission GCU security information corresponding to the transmission GCU identifier and perform authentication of the global data packet based on a comparison result of the transmission GCU authentication value and the global authentication value, and
wherein the reception GCU is configured to transmit the local data packet to the reception ECU corresponding to the reception ECU identifier when the authentication for the global data packet is successful and stop transmission of the local data packet when the authentication of the global data packet is unsuccessful.

10. The security network system of claim 7, wherein the reception GCU is configured to, when authentication of a global data packet transmitted from the transmission GCU is successful, omit authentication of a subsequent global data packet transmitted from the transmission GCU during an effective time interval.

11. The security network system of claim 6, further comprising a central controller connected to the global bus, wherein the central controller includes a central security checker configured to:
store a plurality of GCU security information respectively corresponding to the plurality of GCUs;
upon receiving the global data packet from the transmission GCU, extract from the plurality of GCU security information a transmission GCU security information corresponding to the transmission GCU identifier; and
perform authentication of the global data packet based on the transmission GCU security information and the transmission GCU authentication value included in the global data packet.

12. The security network system of claim 11, wherein the central security checker is configured to generate a global authentication value based on the transmission GCU security information and perform authentication of the global data packet based on a comparison result of the transmission GCU authentication value and the global authentication value.

13. The security network system of claim 1, wherein the GCU is a domain control unit (DCU) to which ECUs performing similar functions are connected, or a zone control unit (ZCU) to which ECUs included in a same physical zone of the vehicle are connected.

14. The security network system of claim 1, wherein the first security checker includes:
a log storage configured to store a history of authentication of the local data packets.

15. The security network system of claim 1, wherein the GCU is configured to, when authentication of a global data packet transmitted from a second GCU of the plurality of GCUs is successful, omit authentication of a subsequent global data packet transmitted from the second GCU during an effective time interval.

16. The security network system of claim 1, wherein the GCU further includes:
a queuing circuit configured to store a plurality local data packets, including the local data packet, transmitted to the GCU; and
a control logic circuit, wherein the control logic circuit is configured to adjust a processing order of the plurality local data packets by the GCU using priority information included in the local data packet.

17. A security network system mounted inside a vehicle, comprising:
a security checker; and
a plurality of electronic control units (ECUs), wherein an ECU of the plurality of ECUs is connected to the security checker via a local bus and the ECU is configured to transmit a local data packet including a transmission ECU identifier, a transmission ECU authentication value, and a reception ECU identifier to the security checker via the local bus,
wherein the security checker is configured to:
store a plurality of ECU security information corresponding to the plurality of ECUs;
upon receipt of the local data packet, extract from the plurality of ECU security information a transmission ECU security information corresponding to the transmission ECU identifier included in the local data packet; and
perform authentication of the local data packet based on the transmission ECU security information and the transmission ECU authentication value included in the local data packet.

18. A communication method of a security network system inside a vehicle, comprising:
storing, in a security checker, a plurality of electronic control unit (ECU) security information corresponding to a plurality of ECUs;
receiving, by the security checker, a local data packet including a transmission ECU identifier, a transmission ECU authentication value, and a reception ECU identifier;
extracting, by the security checker, from the plurality of ECU security information a transmission ECU security information corresponding to the transmission ECU identifier; and
performing, by the security checker, authentication of the local data packet based on the transmission ECU security information and the transmission ECU authentication value.

19. The communication method of claim 18, further comprising:
generating, by the security checker, a local authentication value based on the transmission ECU security information corresponding to the transmission ECU identifier;
performing, by the security checker, the authentication of the local data packet based on a comparison result of the transmission ECU authentication value and the local authentication value; and
transmitting the local data packet to a reception ECU corresponding to the reception ECU identifier included in the local data packet when authentication of the local data packet is successful.

20. The communication method of claim 18, further comprising:
generating, by the security checker, a global data packet by adding a transmission group control unit (GCU) identifier corresponding to a transmission GCU, a transmission GCU authentication value, and a reception GCU identifier corresponding to a reception GCU to which a reception ECU corresponding to the reception ECU identifier included in the local data packet is connected; and
transmitting the global data packet to the reception GCU via a global bus;
storing, by the reception GCU including a second security checker, a plurality of GCU security information respectively corresponding to a plurality of GCUs including the transmission GCU and the reception GCU;
extracting, by the second security checker of the reception GCU receiving the global data packet, from the plurality of GCU security information a transmission GCU security information corresponding to the transmission GCU identifier;
generating, by the second security checker, a global authentication value based on the transmission GCU security information corresponding to the transmission GCU identifier; and
performing, by the second security checker, authentication of the global data packet based on a comparison result of the transmission GCU authentication value and the global authentication value; and
transmitting the local data packet to the reception ECU corresponding to the reception ECU identifier when the authentication for the global data packet is successful.
